(19) United States
(12) Patent Application Publication
(10) Pub. No.: US 2018/0104919 A1
(43) Pub. Date: Apr. 19, 2018

(54) METHOD FOR PRODUCING CONTACT LENSES

(71) Applicant: Novartis AG, Basel (CH)

(72) Inventors: Honghui Lu, Johns Creek, GA (US); Uwe Haken, Norcross, GA (US); Xuxian Niu, San Ramon, CA (US); Alexander W. Kim, Johns Creek, GA (US)

(21) Appl. No.: 15/782,550

(22) Filed: Oct. 12, 2017

Related U.S. Application Data
(60) Provisional application No. 62/408,250, filed on Oct. 14, 2016.

(51) Int. Cl. B29D 11/00

(52) U.S. Cl. CPC B29D 11/00192; B29D 11/0023

(57) ABSTRACT

The invention provides a process for casting—molding contact lenses with enhanced quality and enhanced yield achieved by omitting the previously required check to discover on or in which mold half the contact lens is located after the mold has been opened. The process of the invention includes: providing a mold including a first mold half having a first molding surface and a second mold half having a second molding surface, wherein the first and second mold halves are configured to receive each other such that a mold cavity is formed between the first and second molding surfaces, wherein one of the first and second mold halves has a collar that encircles the other mold half to provide a seal between the two mold halves when the mold is closed; dispensing a polymerizable lens-forming material into one of the mold halves; mating the mold halves to close the mold; polymerizing the polymerizable material located between the two mold halves, thereby forming a molded contact lens; applying a force to non-optical surface of the female mold with a pin at a location about the center area of non-optical molding surface of the mold to deform the female mold thereby breaking the bonds between the optical molding surface of the female mold and the lens and opening the mold.

This application claims the benefits under 35 USC § 119 (e) of U.S. provisional application No. 62/408,250 filed 14 Oct. 2016, herein incorporated by reference in its entirety.

The present invention is related to an improved method for producing contact lenses.

### BACKGROUND OF THE INVENTION

Contact lenses can be manufactured economically in large numbers by a conventional full-mold process involving disposable molds, the examples of which are disclosed in, for example, PCT patent application no. WO/87/04390, in EP-A 0 367 513 or in U.S. Pat. No. 5,894,002. In a conventional molding process, a predetermined amount of a polymerizable or crosslinkable material typically is introduced into a disposable mold including a female (concave) mold half and a male (convex) mold half. The female and male mold halves cooperate with each other to form a mold cavity having a desired geometry for a contact lens. A minor surplus of polymerizable or crosslinkable material may be used so that when the male and female halves of the mold are closed it is ensured that the mold cavity is completely filled, and any excess amount of the material is expelled out into an overflow area adjacent to the mold cavity. The polymerizable or crosslinkable material remaining within the mold is polymerized or cross-linked by means of actinic radiation (e.g., UV irradiation, ionized radiation, microwave irradiation) or by means of heating. Both the starting material in the mold cavity and the excess material in the overflow area are thereby hardened. Subsequently, the mold is opened and the polymerized but as yet unhydrated contact lens is removed and further processed.

Unfortunately, it is often not possible to predict reliably to which of the two mold halves the contact lens will adhere: in some cases it adheres to the male mold half (mold half with the convex optical molding surface) and, in others, it stays in the female mold half (mold half with the concave optical molding surface). After opening of the mold, therefore, a check generally needs to be made to discover on or in which mold half the polymerized but as yet unhydrated contact lens is located.

Therefore, there is a need to provide a process for casting molding contact lenses with enhanced quality and enhanced yield achieved by omitting the previously required check to discover on or in which mold half the contact lens is located after the mold has been opened. Therefore, the process can nevertheless proceed automatically since it can reliably be assumed that the contact lens will adhere to one of the two mold halves. The process can also be simplified to need to optimize only for one mold half.

### SUMMARY OF THE INVENTION

The invention provides a method for producing contact lenses, including:

(a) providing a mold including a female mold half having a first optical molding surface and a male mold half having a second optical molding surface, wherein the female and male mold halves are configured to receive each other such that a mold cavity is formed between the first and second optical molding surfaces, wherein one of the first and second mold halves has a collar that encircles the other mold half to provide a seal between the two mold halves when the mold is closed;

(b) dispensing a polymerizable lens-forming material into female mold halves; mating the mold halves to close the mold;

(c) polymerizing the polymerizable material located between the two mold halves, thereby forming a molded contact lens;

d) applying a restraining force to female mold half for maintaining the female mold half in a fixed position;

e) applying a force to non-optical surface of the female mold with a pin at a location about the center area of non-optical molding surface of the mold to deform the female mold thereby breaking the bonds between the optical molding surface of the female mold and the lens, and

(f) applying a vertical lifting movement to the male mold while maintaining the restraints on the female mold so as to effectuate gradual separation between the female mold and the male mold,

wherein the contact lens adheres to the male mold when separating the mold, provided that the molding surfaces of the female mold and male mold are not treated before or after dispensing a polymerizable lens-forming material into female mold halves to render the molded contact lens preferentially adhered to the female mold or male mold when separating the mold.

The invention also provides an apparatus for demolding contact lenses from molds including a female mold half having a first optical molding surface and a male mold half having a second optical molding surface, wherein the female and male mold halves are configured to receive each other such that a mold cavity is formed between the first and second optical molding surfaces, each of the female mold and the male mold having circular circumferential flanges, the apparatus including:

a mold-prying device, and

a pin-pushing device,

wherein the mold-prying device includes two sets of pry fingers, wherein the two sets of pry fingers are inserted between the circular circumferential flanges of each female mold and male mold of the contact lens mold assembly, a first set of pry fingers located above the flange of the female mold for keeping the female mold in a fixed position and a second set of pry fingers located beneath the flange of the male mold for lifting movement,

wherein the pin-pushing device has a pin for applying a force to non-optical surface of the female mold at a location about the center area of non-optical molding surface along the longitudinal axis of the mold to deform the female mold to compress the female mold between the pin and the first set of pry fingers so as to break the bonds between the optical molding surface of the female mold and the lens, thereby the lens adhere to the male mold when separating the mold.

The present invention provides the foregoing and other features, and the advantages of the invention will become further apparent from the following detailed description of the presently preferred embodiments, read in conjunction with the accompanying figures. The detailed description and figures are merely illustrative of the invention and do not limit the scope of the invention, which is defined by the appended claims and equivalents thereof.

### BRIEF DESCRIPTION OF THE DRAWINGS

FIG. 1 is a cross-sectional view of a mold according to a preferred embodiment of the invention.

FIG. 2 illustrates schematically a process for separating the male and female mold halves of a lens-forming mold according to the invention and an apparatus for performing a method of the invention.

### DESCRIPTION OF PREFERRED EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term.

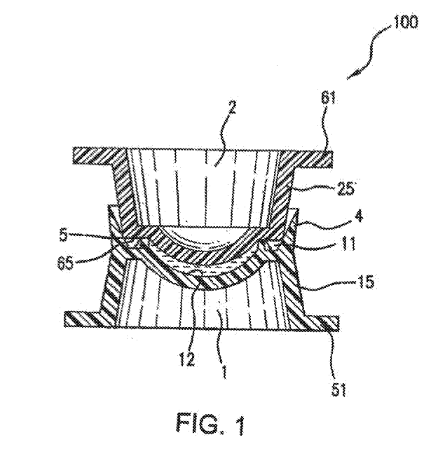

FIG. 1 schematically illustrates a preferred mold 100 used in the methods and apparatus of the invention. The mold 100 includes a female mold half 1 and male mold half 2.

The male mold half 2 includes a base 61, a substantially cylindrical body 25 which extends upward from base 61, a generally convexly-shaped optical molding surface defining the posterior (concave) surface of a molded contact lens, and an annular shoulder 65 which surrounds the optical molding surface. The optical molding surface of the male mold half protrudes outward from the body 25. The annular shoulder 65 shown is flat. It is understood that the annular should 65 can have any suitable surface, such as, e.g., a tilted surface. The male mold half also has a non-optical mold surface, which is the generally concave-shaped area or surface on the opposite side from the convexly-shaped optical molding surface.

The female mold half 1 includes a base 51, a substantially cylindrical body 15 which extends upward from base 51, a generally concave-shaped optical molding surface defining the anterior (convex) surface of a molded contact lens, and a collar 4. The optical molding surface of the female mold half recesses downward from the top of the body 15. Collar 4 (or up-protruding flange) is preferably integral part of the female mold half 1 and protrudes upward from the top of the body 15. A circumferential groove (or recessed area) 11 is formed on top of the body 15 outside of the optical molding surface and functions as an overflow for any excess polymerizable lens-forming material. The female mold half also has a non-optical mold surface, which is the generally convexly-shaped area or surface on the opposite side from the concave-shaped optical molding surface.

The term “collar” as used herein refers to a peripheral circular part which protrudes upward from the top of body of one of the two mating mold halves. A collar can be attached to or preferably be an integral part of that mold half and which can encircle the other mold half to provide a tight seal between the two mold halves. It is understood that the collar can be provided on either of the male and female mold halves.

The female mold half 1 and a male mold half 2 are configured to receive each other such that a contact lens forming cavity 12 is formed between the optical molding surfaces of the male mold half and the female mold half. The collar 4 encircles the body 25 of the male mold half 2 to provide a tight seal 5 between the female and male mold halves when the mold is closed. Typically, there is no lens material in the seal.

In operation, mold halves 1 and 2 can be first injection molded from a plastic resin in an injection molding apparatus, as well known to a person skilled in the art. A specific amount, e.g., an amount sufficient to fill the mold cavity without introducing too much waste, of a polymerizable lens-forming material is typically dispensed into the female mold half 1 by means of a dispensing device. Thereafter, the male mold half 2 is put on and the mold 100 is closed (FIG. 1). As the mold 100 closes, if there is any excess polymerizable lens-forming material, it will be pressed into an overflow area 11 provided on the female mold half 1.

Subsequently, the closed mold 100 containing the polymerizable lens-forming material is subjected to actinic irradiation (e.g., UV radiation or visible light radiation), or heat radiation, at least in the region of the lens forming cavity 12. For this purpose, at least one of the mold halves is transparent to the actinic radiation (e.g., UV light) at least in the region of the molding surface. Thus, at least the polymerizable lens-form ing material in the lens forming cavity 12 is polymerized. It is also possible for any polymerizable lens-forming material in the overflow area 11 to be polymerized. This is advantageous in the respect that, when the mold is opened, the excess polymerized lens-forming material then remains in the overflow area 11 of the female mold half 1, while the contact lens adhering to the male mold half 2 can be removed and further processed together with male mold half 2.

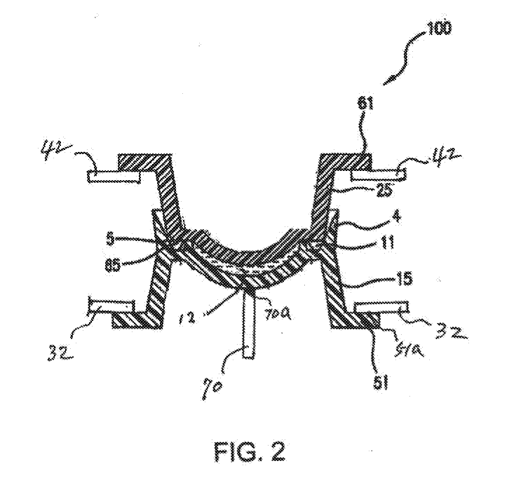

Subsequently, applying a force to non-optical surface of the female mold at a location about the center area of non-optical molding surface at an angle of less than about 30 degrees, preferably less than about 10 degrees, most preferably less than about 5 degrees (i.e., in a direction substantially normal to center area of non-optical molding surface) relative to the axis of the mold to deform the female mold surface which breaks the bonds between the optical molding surface of the female mold and the lens, as shown in FIG. 2. Various ways of applying a force to non-optical surface of the female mold at a location about the center area of non-optical molding surface along the axis of the mold to deform the female mold surface which breaks the bonds between the optical molding surface of the female mold and the lens. It is understood that the mold-opening device can have any configurations known to a person skilled in the art for performing the function of separating two mold halves from each other. For example, referring to FIG. 2, the demolding assembly includes a pin 70 positionable against the center area of the non-optical molding surface of the female mold section. The pin 70 may have a flat free end 70a to enable a surface contact between the free end 70a and the center area of non-optical molding surface of the female mold. It will be appreciated that the scope of the invention is not limited to such a particular flat configuration of the pin end 70a, for example the pin may have a or a somewhat concave-shaped free end to more closely match the shape of the shape of the non-optical molding surface of the female mold half, or a somewhat convexly rounded free end to more closely match the shape of the shape of the non-optical molding surface of the male mold half. In the present embodiment, the pin 70 is movable and the female mold remains stationary by applying a restraining force to female mold half applying a restraining force to female mold half with a first pry finger set 32 for maintaining the female mold half in a fixed position. However, it is possible to arrange the assembly so that the female mold is movable toward the pin 70 while the pin 70 remains stationary, or so that both the pin 70 and the female mold can be moved relative to each other.

In use, during the demolding operation, the free end 70a of the pin 70 applies a longitudinally directed force to the central portion of the non-optical surface of the female mold. The first pry finger set 32 applies a counteractive force against the end face 51a of the flange 51 of the female mold section 1. Consequently, the female mold section is deformed or compressed between the free end 70a of the pin 70 and the first pry finger set 32. The force acts to deform the curved part of the female mold section and breaks the adhesive bond between the lens-forming optical surface of the female mold section 1 and the anterior surface of the lens. In this fashion, the adherence force between the lens and the optical surface of the female mold half is reduced, and therefore the lens is more likely to remain adhered to the optical surface of the male mold half.

Then, apply a vertical lifting movement to the male mold with a second pry finger set (while maintaining the restraints on the female mold so as to effectuate gradual separation between the female mold and the male mold.

After separating the male mold and the female mold, the contact lens adheres to the male mold even though the molding surfaces of the female mold and male mold are not treated before or after dispensing a polymerizable lens-forming material into one of the mold halves to render the molded contact lens preferentially adhered to the female mold or male mold when separating the mold.

After breaking the bond between the optical molding surface of the female mold and the lens, the mold is separated, the molded contact lens adhering to the male mold half 2. It is surprising to find out that, according to the present invention, the molded contact lens typically adheres to the male mold half even though the molding surfaces of the female mold and male mold are not treated (before or after dispensing of the polymerizable lens-forming material) to render the molded contact lens preferentially adhered to the female mold or male mold when separating the mold.

Once the mold sections have been separated, the lens will adhere to a surface of the male mold sections and must therefore be released from the male mold section. According to the present application as mentioned above, the lens typically remains adhered to the male mold section. Both wet and dry release methods of lens release have been proposed in the prior art. In wet lens release methods, an aqueous solution is used to wet the hydrophilic lens which absorbs water and swells, causing the lens to separate from the mold surface. For example, wet release methods are discussed in U.S. Pat. No. 5,264,161. In dry release methods, the lens is removed from the associated mold surface while still in the dry state. For example, dry release methods are discussed in U.S. Pat. No. 5,271,875.

Once the lens is released from the male mold section, the released lens will be hydrated. Any hydration device can be used in the invention.

In another aspect, the invention provides an apparatus for demolding contact lenses from molds including a female mold half having a first optical molding surface and a male mold half having a second optical molding surface, wherein the female and male mold halves are configured to receive each other such that a mold cavity is formed between the first and second optical molding surfaces, each of the female mold and the male mold having circular circumferential flanges, the apparatus including:

a mold-prying device, and

a pin-pushing device,

wherein the mold-prying device includes two sets of pry fingers, wherein the two sets of pry fingers are inserted between the circular circumferential flanges of each female mold and male mold of the contact lens mold assembly, a first set of pry fingers located above the flange of the female mold for keeping the female mold in a fixed position and a second set of pry fingers located beneath the flange of the male mold for lifting movement,

wherein the pin-pushing device has a pin for applying a force to non-optical surface of the female mold at a location about the center area of non-optical molding surface along the longitudinal axis of the mold to deform the female mold to deform or compress the female mold between the pin and the first set of pry fingers so as to break the bonds between the optical molding surface of the female mold and the lens, thereby the lens adheres to the male mold when separating the mold.

It is understood that methods of manufacturing mold halves for cast molding a contact lens are generally well known to those of ordinary skill in the art. The process of the present invention is not limited to any particular method of forming a mold half. In fact, any method of forming a mold half can be used in the present invention. However, for illustrative purposes, the above discussion has been provided as one embodiment of forming mold halves that can be used in accordance with the present invention.

A “polymerizable lens-forming material” refers to a material which can be polymerized and/or crosslinked by actinic radiation to form a contact lens. A lens-form ing material can be any materials known to a skilled artisan. For example, a polymerizable lens-forming material can be a fluid composition (i.e., a solution or a solvent-free liquid or melt at a temperature below 60° C.) including one or more prepolymers, one or more monomers, one or more macromers, or combinations thereof. A lens-forming material can further include other components, such as a photoinitiator, a visibility tinting agent, UV-blocking agent, photosensitizers, heat initiators, and the like. Preferably, a polymerizable lens-forming material used in the present invention can form a hydrogel material and more preferably can form a silicone hydrogel.

“Polymerizing the polymerizable material” refers to the polymerizable material can be cured or polymerized by actinic radiation.

“Actinic radiation” refers to radiation of a suitable form of energy. Examples of actinic radiation includes without limitation light radiation (e.g., UV radiation), gamma radiation, electron radiation, X-ray irradiation, microwave irradiation, thermal radiation and the like. According to the present invention, preferably, a polymerizable lens-form ing material is polymerized by a thermal radiation.

A “hydrogel material” refers to a polymeric material which can absorb at least 10 percent by weight of water when it is fully hydrated. Generally, a hydrogel material is obtained by polymerization or copolymerization of at least one hydrophilic monomer in the presence of or in the absence of additional monomers and/or macromers. Exemplary hydrogels include, but are not limited to, poly(vinyl alcohol) (PVA), modified polyvinylalcohol (e.g., as nelfilcon A), poly(hydroxyethyl methacrylate), poly(vinyl pyrrolidone), PVAs with polycarboxylic acids (e.g., carbopol), polyethylene glycol, polyacrylamide, polymethacrylamide, silicone-containing hydrogels, polyurethane, polyurea, and the like. A hydrogel can be prepared according to any methods known to a person skilled in the art.

A “silicone hydrogel” refers to a hydrogel containing silicone. A silicone hydrogel typically is obtained by copolymerization of a polymerizable composition including at least one silicone-containing vinylic monomer or at least one silicone-containing vinylic macromer or at least one silicone-containing prepolymer having ethylenically unsaturated groups.

A “vinylic monomer” refers to a compound that has one sole ethylenically-unsaturated group.

The term “olefinically unsaturated group” or “ethylenically unsaturated group” is employed herein in a broad sense and is intended to encompass any groups containing at least one >C═C< group.

Various embodiments are evident. Although one mold (FIG. 1) is illustrated, the invention is in no way limited to this specific mold. A person skilled in the art can readily determine other molds for which the invention has applicability.

The invention has been described in detail, with particular reference to certain preferred embodiments, in order to enable the reader to practice the invention without undue experimentation. A person having ordinary skill in the art will readily recognize that many of the previous components, compositions, and/or parameters may be varied or modified to a reasonable extent without departing from the scope and spirit of the invention. Furthermore, titles, headings, example materials or the like are provided to enhance the reader's comprehension of this document, and should not be read as limiting the scope of the present invention. Accordingly, the invention is defined by the following claims, and reasonable extensions and equivalents thereof.

What is claimed is:

1. A method for producing contact lenses, comprising:
(a) providing a mold including a female mold half having a first optical molding surface and a male mold half having a second optical molding surface, wherein the female and male mold halves are configured to receive each other such that a mold cavity is formed between the first and second optical molding surfaces, wherein one of the first and second mold halves has a collar that encircles the other mold half to provide a seal between the two mold halves when the mold is closed;
(b) dispensing a polymerizable lens-forming material into one of the mold halves and mating the mold halves to close the mold;
(c) polymerizing the polymerizable material located between the two mold halves, thereby forming a molded contact lens;
d) applying a restraining force to the female mold half with a first pry finger set for maintaining the female mold half in a fixed position;
e) applying a force to the non-optical surface of the female mold with a pin at a location about the center area of non-optical molding surface of the mold to deform the female mold thereby breaking the bonds between the optical molding surface of the female mold and the lens, and
(f) applying a vertical lifting movement to the male mold with a second pry finger set while maintaining the restraints on the female mold so as to effectuate gradual separation between the female mold and the male mold,
wherein the contact lens adheres to the male mold when separating the mold, provided that the molding surfaces of the female mold and male mold are not treated before or after dispensing the polymerizable lens-forming material into one of the mold halves to render the molded contact lens preferentially adhered to the female mold or male mold when separating the mold.

2. The method of claim 1, wherein the force is applied non-optical surface of the female mold with a pin at a location about the center area of non-optical molding surface at an angle of less than about 30 degrees relative to the longitudinal axis of the mold.

3. The method of claim 2, wherein the force is applied to non-optical surface of the female mold with a pin at a location about the center area of non-optical molding surface at an angle of less than about 10 degrees relative to the longitudinal axis of the mold.

4. The method of claim 3, wherein the force is applied non-optical surface of the female mold with a pin at a location about the center area of non-optical molding surface at an angle of less than about 5 degrees relative to the longitudinal axis of the mold.

5. The method of claim 1, wherein the polymerizable lens-forming material comprises at least one silicone-containing vinylic monomer or at least one silicone-containing vinylic macromer or at least one silicone-containing prepolymer having ethylenically unsaturated groups.

6. The method of claim 5, wherein the polymerizable lens-forming material is polymerized by thermal curing.

7. An apparatus for demolding contact lenses from molds including a female mold half having a first optical molding surface and a male mold half having a second optical molding surface, wherein the female and male mold halves are configured to receive each other such that a mold cavity is formed between the first and second optical molding surfaces, each of the female mold and the male mold having circular circumferential flanges, the apparatus comprising:
a mold-prying device, and
a pin-pushing device,
wherein the mold-prying device comprising two sets of pry fingers, wherein the two sets of pry fingers are inserted between the circular circumferential flanges of each female mold and male mold of the contact lens mold assembly, a first set of pry fingers located above the flange of the female mold for keeping the female mold in a fixed position and a second set of pry fingers located beneath the flange of the male mold for lifting movement, wherein the pin-pushing device has a pin for applying a force to non-optical surface of the female mold at a location about the center area of non-optical molding surface and along the longitudinal axis of the mold to deform the female mold between the pin and the first set of pry fingers so as to break the bonds between the optical molding surface of the female mold and the lens, thereby the lens adheres to the male mold when separating the mold.

8. The apparatus of claim 7, wherein the pin-pushing device is capable of applying a force directly to non-optical surface of the female mold with at a location about the center area of non-optical molding surface at an angle of less than about 30 degrees relative to the longitudinal axis of the mold.

9. The apparatus of claim 8, wherein the pin-pushing device is capable of applying a force directly to non-optical surface of the female mold with at a location about the center area of non-optical molding surface at an angle of less than about 10 degrees relative to the longitudinal axis of the mold.

10. The apparatus of claim 9, wherein the pin-pushing device is capable of applying a force directly to non-optical surface of the female mold with at a location about the center area of non-optical molding surface at an angle of less than about 30 degrees relative to the longitudinal axis of the mold.
